(19) United States
(12) Patent Application Publication
(10) Pub. No.: US 2015/0189834 A1
(43) Pub. Date: Jul. 9, 2015

(54) THRESHING DRUM AND MOBILE THRESHING DEVICE EQUIPPED WITH SUCH A THRESHING DRUM

(71) Applicant: Joachim HAASE, Hannover (DE)

(72) Inventor: Joachim Haase, Hannover (DE)

(21) Appl. No.: 14/414,466

(22) PCT Filed: Jun. 11, 2013
(86) PCT No.: PCT/DE2013/100211

§ 371 Date: Jan. 13, 2015

(30) Foreign Application Priority Data
Jul. 13, 2012 (DE) 10 2012 106 338.9

(51) Int. Cl. A01F 12/20; A01F 12/24; A01F 12/46; A01F 7/02

(52) U.S. Cl. CPC A01F 12/20; A01F 7/02; A01F 12/24; A01F 12/46

(57) ABSTRACT

A threshing drum includes beater arms which are arranged on a circumferential surface of the threshing drum so as to be movable relative to a threshing concave that is disposed adjacent to the threshing drum. At least one of the beater arms is equipped over a periphery thereof with at least one beater body that is movably drivable relative to the at least one of the beater arms.

CROSS-REFERENCE TO PRIOR APPLICATIONS

This application is a U.S. National Phase Application under 35 U.S.C. §371 of International Application No. PCT/DE2013/100211, filed on Jun. 11, 2013, and claims benefit to German Patent Application No. DE 10 2012 106 338.9, filed on Jul. 13, 2012. The International Application was published in German on Jan. 16, 2014 as WO 2014/008887 under PCT Article 21(2).

### FIELD

The invention relates to a threshing drum comprising beater arms which are arranged on the circumferential surface of said drum so as to be movable relative to a threshing concave that is adjacent to the threshing drum and which are, in particular, movably arranged having a movement component that is transverse to the main conveying direction. The invention also relates to a movable threshing device, in particular a combine harvester, which is equipped with a threshing drum that can be rotationally movably driven about an axis of rotation and with a threshing concave arranged so as to be adjacent to the threshing drum, and is intended for field crops or grain.

### BACKGROUND

Modern agricultural threshing devices, in particular combine harvesters, are complex machines that can harvest, thresh and separate agriculturally grown crops which in particular bear grains. The clean grain obtained is stored in a grain tank arranged on the combine harvester. Tangential threshing apparatuses which comprise a threshing concave and a threshing drum which conveys the crop tangentially or axial threshing apparatuses which convey the crop axially and comprise axial threshing rotors that also cooperate with a threshing concave are generally used for threshing.

The threshing concaves are usually composed of outer cheeks, curved bars arranged in parallel therebetween and threshing bars, between which gaps are left, in which concave wires oriented in parallel with the curved bars are located. The threshing concave surrounds the threshing drum over part of the circumference thereof and encloses therewith an aperture through which the crop to be threshed is forced.

As the crop is conveyed through the aperture, parts of the crop, in particular the grain, are cut off, which grain falls through the gaps and is conveyed to a cleaning apparatus. Owing to the nature of the crop, parts thereof may break off more or less easily, and therefore it is useful to be able to adjust the threshing concaves to each crop.

Owing to the distance of the beater arms from the threshing concave, the conveying aperture is provided as a through-opening. The size of this through-opening is crucial for the efficiency of the threshing of different types of crop; therefore, differently sized through-openings are required for different types of crop. For example, larger through-openings are required for grains of maize than for grains of wheat.

If the conveying aperture is too great, a large amount of non-grain constituents are deposited on the threshing concave, thus leading to relatively heavy soiling of the grains deposited on the threshing concave. By contrast, too small a conveying aperture leads to the through-openings and thus the threshing concave becoming blocked. At the same time, the risk of the grain being broken increases, since the non-threshed crop piles up above the grain deposit surface due to the crop following thereafter and is also contacted by the threshing drum in an unabating manner.

It is essential to keep losses of grain to an acceptable minimum value and also to achieve a uniform flow of crop material through the threshing and separating mechanisms.

For an apparatus consisting of a threshing drum and a threshing concave, it has therefore already been proposed to vary the distance of the threshing concave from the circumferential surface of the threshing drum by means of an appropriate rod assembly.

In the category-defining patent DE 12 63 388 A, a beater arm of the threshing drum is movable in the axial direction of the threshing drum transversely to the main conveying direction in order to provide an option for changing the size of the gap between a threshing drum and a threshing concave surrounding said drum. In this way, an adaptation to the material to be threshed out can be carried out by it being possible to change the diameter of the threshing drum and/or of the threshing concave and thus the distance from the concave using a rod assembly.

In a threshing device known from DE 950 158 B, the power consumption of a threshing machine and the power dissipation referred to as fan performance are intended to be reduced, by the beater arms being used in the form of aerodynamically favourable profiles, for example wing profiles. Said profiles are also movably arranged so that the chordal direction of the profile is periodically changed in a predetermined manner by an actuating means during a revolution of the threshing drum.

In order to increase the possible scope of application of combine harvesters, it is also already known to retrofit the threshing drums and provide them with different additional apparatuses such that a plurality of types of crop to be threshed can be harvested.

When threshing grain maize and some specialised crops, for example in the circumferential region of the threshing drum, the free gaps between adjacent beater arms are provided with profiled or planar cover plates, as described in U.S. Pat. No. 3,856,022 A1, in order to prevent crops from penetrating into the open inner space in the threshing drum, in particular at low rotational speeds.

DE 31 23 992 A1 discloses adjustable cover plates which bridge the free gaps between adjacent beater arms. The respective positions of the cover plates can be adjusted according to the crop via an adjustment apparatus.

In a design known from DE 10 2009 015 235 A1, a plurality of spaced-apart U-shaped support profiles are fastened to the circumferential surface of a rotatably driven cylindrical drum body, to which profiles the beater bars are releasably attached by means of screwed connections.

In addition, DE 27 42 067 A1 describes a rotary combine harvester comprising a threshing unit, the threshing drum comprising approximately radially projecting beater plates which extend over the width of the drum and which may be formed so as to be resilient at least in the edge region thereof or have a resilient beater arm on the edge thereof.

DD 247 594 A1 also discloses beater arms for threshing drums which have different degrees of hardness or case depths from the side to the centre of the threshing drum according to the different levels of wear.

It is also known from DE 689 07 640 T2 to reduce grain losses which occur by means of a structural design as an axial-flow combine harvester. In this design, the harvested material is subjected to a significantly longer threshing and separation effect than in a conventional machine of comparable size, and therefore the efficiency of axial-flow machines is greater.

### SUMMARY

In an embodiment, the present invention provides a threshing drum. The threshing drum includes beater arms which are arranged on a circumferential surface of the threshing drum so as to be movable relative to a threshing concave that is disposed adjacent to the threshing drum. At least one of the beater arms is equipped over a periphery thereof with at least one beater body that is movably drivable relative to the at least one of the beater arms.

### BRIEF DESCRIPTION OF THE DRAWINGS

The present invention will be described in even greater detail below based on the exemplary figures which are schematic in nature. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a side view of a threshing device according to an embodiment of the invention comprising a threshing drum;

FIG. 2 is a side view of a variant of the threshing device according to an embodiment of the invention;

FIG. 3 is a front view of an embodiment of the threshing drum, shown in FIG. 1 or 2, comprising beater arms which are movable in translation;

FIG. 4 is a front view of a further embodiment of a threshing drum comprising beater bodies, arranged so as to move in a revolving manner, of a beater arm;

FIG. 5 is a front view of a further embodiment of a threshing drum comprising inclined rotational bodies; and

FIG. 6 is a front view of a further embodiment of a threshing drum comprising spherical beater bodies.

### DETAILED DESCRIPTION

In practice, the structural complexity associated primarily with the multiple-step separation process and the production costs associated therewith have proven disadvantageous. Furthermore, the known combine harvesters are of considerable size, which makes handling considerably more difficult, in particular on public roads.

In common combine-harvester designs, the straw walkers downstream of the threshing drum also require the entire vehicle to be substantially horizontally oriented as a second processing step, and therefore appropriate options for adjustment need to be provided on the chassis.

In an embodiment, the invention provides an option for designing a threshing drum and a movable threshing device of the type mentioned at the outset such that it can be produced so as to be compact with a simultaneously high level of efficiency. Furthermore, the structural complexity compared with the movable threshing devices known from the prior art is significantly reduced.

According to an embodiment of the invention, a threshing drum is therefore provided in which at least one beater arm is equipped over its periphery with at least one beater body that can be movably driven relative to the beater arm. An embodiment of the invention proceeds from the concept that the grain can be separated from the straw or the chaff particularly efficiently if, in the conveying aperture between the threshing drum and the threshing concave, a superposed acceleration of the crop occurs both in the main flow direction and tangentially to the threshing drum, and an additional movement component occurs transversely thereto and in parallel with the circumferential surface of the threshing drum. Although the associated physical effect underlying a surprising increase in efficiency has not yet been completely understood, it can be assumed from current knowledge of the inventor that owing to the additional movement component, an additional rotational movement of the crop takes place about an axis that extends in parallel with the main flow direction. This movement, which is also referred to as a rolling movement, accordingly leads to the grain being rapidly separated from the straw. As a result, the straw walkers required in the prior art and other systems identified for this purpose which make up a considerable part of the vehicle dimensions in present combine harvesters may be omitted. A reduction, according to an embodiment of the invention, of the dimensions results in the threshing drum not only being able to be used as a component of an autonomous combine harvester, but also being able to be used as a functional unit for being temporarily fixed to agricultural vehicles, preferably comprising a suitable power take-off or alternatively comprising a separate drive unit. It is clear that significant simplification both in handling and manufacture is associated therewith, since the threshing drum according to an embodiment of the invention only makes up a small part of the manufacturing costs of a combine harvester.

It is particularly advantageous if, according to a particularly advantageous embodiment of the present invention, at least one beater arm is movably arranged on the threshing drum having a movement component that is transverse to the main conveying direction. In this way, movement components of this type can also be easily produced which have a non-parallel orientation to the axis of rotation of the threshing drum, in order to thus further increase the efficiency. In addition, the conveying aperture can therefore be adapted to the crop as required, independently of the superposed movements.

A particularly promising embodiment of the present invention is also produced by the threshing drum comprising at least one beater arm and/or by the threshing concave being designed to have beater bodies that can be reversibly driven and are movable in translation, it being possible for the frequency and/or the amplitude of the translational deflection to occur depending on the volume flow rate, the rotational speed of the threshing drum or other operation-dependent parameters of the threshing device. For this purpose, the beater bodies are guided for example in a receiving portion, in particular a profiled rail, and can be driven by means of a connecting rod. Of course, a plurality of beater bodies can be driven in a synchronised manner.

In this case, it has already proven to be particularly promising if different beater arms and/or beater bodies on the threshing drum can be deflectably driven in opposite directions of action in a synchronised manner, in order to ensure even distribution of the crop over the entire width of the threshing drum. In particular, as a result, an increased amount of crop is prevented from undesirably collecting on one side. By the crop being subjected to transverse acceleration in opposite directions of action by successively acting beater arms or beater bodies in a short space of time in the conveying aperture, an additional significant increase in efficiency is also achieved. At the same time, improved mixing of the conveyed crop is achieved thereby.

A particularly advantageous embodiment of the method is also achieved in that at least one beater arm comprises at least one beater body, which is arranged over the circumference of the threshing drum so as to move in a revolving manner, in particular in parallel with the axis of rotation of the threshing drum, in order to thus achieve the desired relative movement by a continuous revolving movement. As a result, the drive of the beater bodies is simplified and at the same time, undesired imbalances which occur periodically are reduced in comparison with a reversing movement. In addition, during the revolving movement, the two lines of the circumferential beater bodies form an upper run and a lower run having opposite movement directions, so that material is prevented from undesirably accumulating on one side.

The lines, referred to as the upper run and the lower run, may extend on the circumferential surface of the threshing drum so as to be adjacent to each other and may assume almost any orientation relative to the axis of rotation of the threshing drum. Variants in which the beater bodies encircle the circumference of the threshing drum several times along a spiral or helical path are also not ruled out.

According to another embodiment of the present invention which is also particularly practical, the beater bodies are arranged so as to be movable in a shared plane extending through the axis of rotation, and are thus on opposite sides relative to the axis of rotation of the threshing drum. In order to achieve simple guidance at the end face, one or more end-face guide rollers may be provided, for example.

Machine elements that are known per se can be used for movably arranging the beater bodies. The beater bodies may thus, for example, comprise pushers which reach through groove-shaped recesses in the circumferential surface of the threshing drum, are operatively connected to a drive element, for example a drive worm, and can be moved along the circumferential surface as a result. Connecting link guides are also conceivable which can also be fixed to the threshing concave for example and impose a transverse acceleration on each beater body when it passes through the conveying aperture. It is, however, particularly simple for the beater bodies to be movably drivable by means of a traction mechanism, for example by means of a belt band, a cable or a chain. This further simplifies the construction and provides a low overall weight of the threshing drum equipped in this way.

According to a further embodiment of the present invention, which is also particularly practical, the threshing drum comprises a plurality of rotationally symmetrical rotational bodies which support at least one beater arm or one beater body and which can each be rotationally movably driven about an axis that is not parallel to the axis of rotation of the threshing drum. Thus, by the beater bodies themselves also being rotationally movably arranged on the rotationally movable threshing drum, the axes of rotation of the threshing drum and the beater bodies having a non-parallel orientation, the desired superposed movement occurs. In this case, the rotational bodies may for example be substantially disc-shaped, or spherical.

A further increase in efficiency is also achieved here in that adjacent rotational bodies are rotationally movable about different axes that not parallel to one another, in order to thus further optimise the process of separating the grain from the straw by means of the opposing transverse acceleration.

Of course, adjacent rotational bodies may be rotationally movably drivable in different rotational directions, in order to thus produce yet more additional movement directions or accelerations in the conveying aperture.

in an embodiment of the invention, a movable threshing device in which at least one beater arm is equipped over its periphery with at least one beater body can be movably driven relative to the beater arm. In this case, the threshing device may be designed both as a self-propelled motor vehicle and as an auxiliary unit with or without its own chassis. In addition, the threshing device may be equipped with its own drive for the threshing drum or may be supplied with the required drive power by an additional vehicle, so that said threshing device for example can also be used as an attachment unit for an agricultural vehicle comprising a power take-off and thus can be produced considerably more cost-effectively compared with known combine harvesters. In any case, considerably smaller dimensions and a dead weight that is reduced overall arise compared with the prior art. Owing to the additional acceleration of the crop occurring in the conveying gap in a direction that significantly differs from the conveying direction, for example a transverse acceleration, as a result a considerably improved separation of straw and grains occurs, and therefore a straw walker in particular can be omitted.

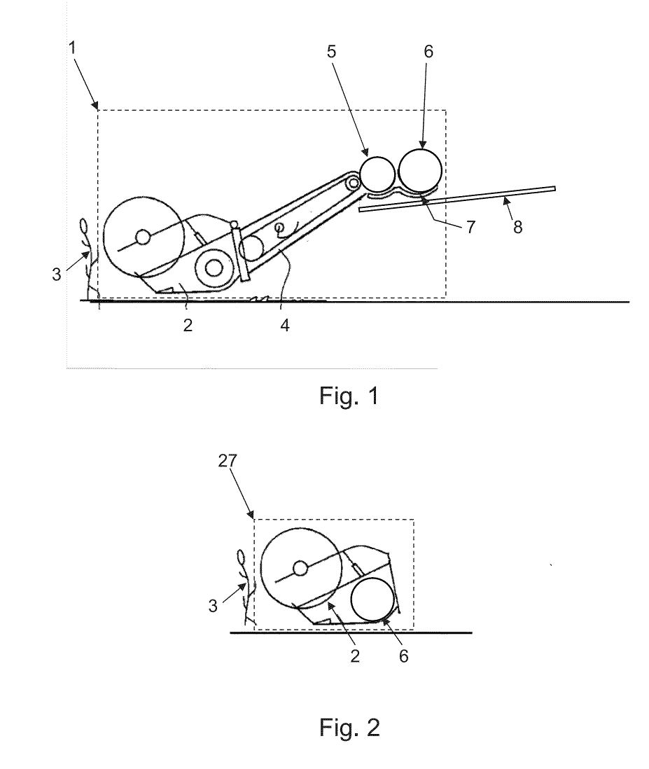

FIG. 1 is a schematic view of a threshing device 1 according to an embodiment of the invention as an attachment unit for agricultural vehicles. In the threshing device 1, the crop 3 cut by a cutting mechanism 2 reaches, via an obliquely upwardly extending feeder channel 4, a threshing means which operates in accordance with the tangential principle and comprises a pre-acceleration drum 5, a threshing drum 6 and a threshing concave 7 associated with the threshing drum. Between the revolving pre-acceleration drum 5, the threshing drum 6 and the stationary threshing concave 7, the grains in the seed heads of the crop 3 are threshed out. The pre-acceleration drum 5 removes the crop 3 from the feeder channel 4, accelerates it and carries it to the threshing drum 6. Together with the short stalks and the chaff, the grains deposited on the threshing concave 7 reach a collecting container via a conveyor 8.

Furthermore, FIG. 2 schematically shows a variant of a threshing device 27 according to an embodiment of the invention which is also designed as an attachment unit for agricultural vehicles, just as the threshing device 1 shown in FIG. 1. In this case, the crop 3 cut by the cutting mechanism 2 is directly conveyed to the threshing drum 6 adjacent to the cutting mechanism 2, which drum takes the place of the feeding screw outlined in FIG. 1. By means of an appropriate design, including the beater bodies of the threshing drum 6, the desired deflection towards the centre of the vehicle is achieved and a collecting function is produced, which makes the further transport of the crop 3 significantly easier. As can be seen, by omitting an additional feeder channel, pre-acceleration drum and conveyor, the threshing device 27 may be produced particularly compactly.

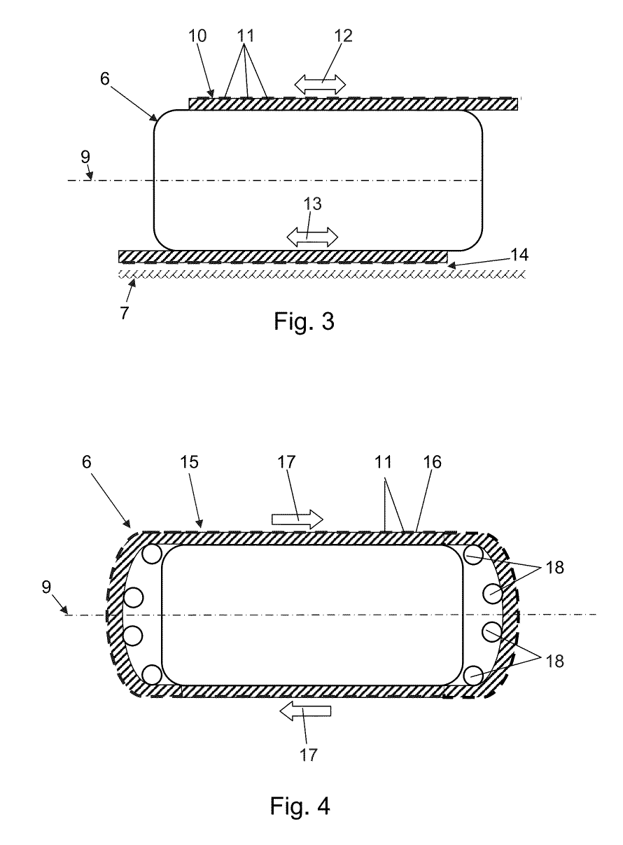

As shown in greater detail in FIG. 3, the threshing drum 6 has a plurality of beater arms 10 which are arranged in parallel with an axis of rotation 9 over the circumferential surface of said drum relative to the threshing concave 7 and comprising beater bodies 11 that are movable in translation. Said beater bodies 11 are movable in parallel with the axis of rotation 9 of the threshing drum 6 in opposite arrow directions 12, 13, independently of the rotational movement of the threshing drum 6. Owing to the acceleration of the crop in the transverse direction in a conveying aperture 14 between the threshing drum 6 and the threshing concave 7, the grain is separated from the straw or the chaff considerably more efficiently than has hitherto been possible using threshing drums according to the prior art. Owing to this increase in efficiency, a straw walker which is required in the prior art can be omitted. Owing to the transverse acceleration transmitted to the crop by means of the beater bodies 11 in opposite arrow directions 12, 13 in the conveying aperture 14 between the threshing drum 6 and the threshing concave 7, the crop is subjected to additional shearing stress, which leads to a gentle and simultaneously highly effective separation of the grain from the straw.

FIG. 4 shows a variant of the threshing drum 6 of which the beater arms 15 comprise a plurality of beater bodies 11, which are connected by a traction mechanism 16 designed as a link chain and arranged so as to move in a revolving manner over the circumference of the threshing drum 6 in a plane shared with the axis of rotation 9 of the threshing drum 6. As a result, opposing transverse accelerations, shown by directional arrows 17, act on opposite sides of the threshing drum 6, so that the crop is prevented from accumulating on one side. In order to achieve simple guidance at the end face, a plurality of guide rollers 18 are provided which are used to deflect the traction mechanism 16.

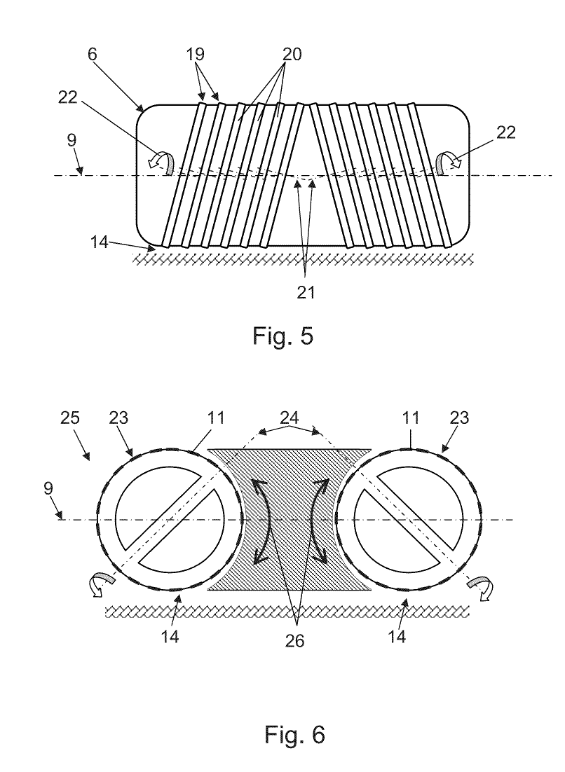

FIG. 5 shows a further variant according to an embodiment of the invention of the threshing drum 6, in which the threshing drum 6 comprises a plurality of disc-shaped rotational bodies 19, the circumferential surfaces of which each comprise a beater arm 20. In this case, similarly to a screw, the rotational bodies 19 have a pitch, but without being interconnected. Each rotational body 19 can be rotationally movably driven in the arrow direction 22 about an axis of rotation 21 that intersects the axis of rotation 9 of the threshing drum 6, so that a movement component is produced in the conveying aperture 14 which leads to the desired increased shearing forces.

If the rotational bodies 23 are designed to be spherical, as shown in FIG. 6, an additional degree of freedom can be produced. For this purpose, the axes of rotation 24 of the rotational bodies 23 supporting the beater bodies can be adjusted independently of one another and independently of the axis of rotation 9 of a threshing drum 25 in the arrow direction 26, so that the direction of action of the superposed accelerating forces in the conveying aperture 14 can be variably adjusted and thus can be optimally adapted to different grains, such as cereals, rapeseed, maize, sunflowers, broad beans, grass seeds or the like.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A threshing drum, comprising:
beater arms which are arranged on a circumferential surface of the threshing drum so as to be movable relative to a threshing concave that is disposed adjacent to the threshing drum, wherein at least one of the beater arms is equipped over a periphery thereof with at least one beater body that is movably drivable relative to the at least one of the beater arms.

2. The threshing drum according to claim 1, wherein at least one of the beater arms comprises beater bodies that are movable in translation and can be reversibly drivable.

3. The threshing drum according to claim 1, wherein at least one of different beater arms and different beater bodies on the threshing drum are movably drivable in opposite directions of action in a synchronised manner.

4. The threshing drum according to claim 1, wherein at least one of the beater arms comprises at least one beater body, which is arranged over a circumference of the threshing drum so as to move in a revolving manner in parallel with an axis of rotation of the threshing drum.

5. The threshing drum according to claim 1, wherein beater bodies are arranged so as to be movable in a shared plane extending through an axis of rotation of the threshing drum.

6. The threshing drum according to claim 1, wherein beater bodies are movably drivable by means of a traction mechanism.

7. The threshing drum according to claim 1, further comprising a plurality of rotationally symmetrical rotational bodies which support at least one of at least one beater arm and at least one beater body and which are rotationally movably drivable about an axis that is not parallel to an axis of rotation of the threshing drum.

8. The threshing drum according to claim 1, further comprising a plurality of rotationally symmetrical rotational bodies which support at least one of at least one beater arm and at least one beater body and which are rotationally movable about different axes that are not parallel to one another.

9. The threshing drum according to claim 1, wherein at least one of at least one beater arm and at least one beater body is movably arranged on the threshing concave.

10. The threshing drum according to claim 1, wherein the threshing drum simultaneously assumes the function of a feeding screw or is integrated into a feeding screw.

11. A movable threshing device, comprising:
a threshing drum that is rotationally movably drivable about an axis of rotation;
a threshing concave arranged so as to be adjacent to the threshing drum; and
at least one beater arm is equipped over a periphery thereof with at least one beater body that is movably drivable relative to the at least one beater arm.
